(19) United States
(12) Patent Application Publication
(10) Pub. No.: US 2017/0298816 A1
(43) Pub. Date: Oct. 19, 2017

(54) GAS TURBINE ENGINE

(71) Applicant: ROLLS-ROYCE plc, London (GB)

(72) Inventors: Ahmad RAZAK, Bristol (GB); Paul FLETCHER, Rugby (GB)

(73) Assignee: ROLLS-ROYCE plc, London (GB)

(21) Appl. No.: 15/292,852

(22) Filed: Oct. 13, 2016

(30) Foreign Application Priority Data
Oct. 27, 2015 (GB) 1518929.3

(51) Int. Cl. F02C 3/113; F02C 9/00; F16H 41/24; F02C 7/22; F16H 61/56; F02C 3/14

(52) U.S. Cl. CPC F02C 3/113; F16H 61/56; F02C 3/14; F16H 41/24; F02C 7/22; F02C 9/00; F05D 2260/406; F05D 2260/4031; F05D 2260/402; F05D 2240/35; F05D 2270/304; F05D 2220/76; F05D 2220/323; F05D 2270/02; F05D 2270/303; F05D 2240/20

(57) ABSTRACT

A gas turbine engine comprises a relatively high pressure compressor coupled to a relatively high pressure turbine by a relatively high pressure shaft; a relatively low pressure compressor coupled to a relatively low pressure turbine by a relatively low pressure shaft rotatable independently of the high pressure shaft; a first combustor located downstream of the high pressure compressor and upstream of the high pressure turbine; and a second combustor located downstream of the high pressure turbine, and upstream of the low pressure turbine. The engine further comprises a coupling arrangement configured to selectively transfer torque between the high pressure shaft and the low pressure shaft.

The present disclosure concerns a gas turbine engine, a method of operating a gas turbine engine, and an aircraft comprising the gas turbine engine.

There is a continual need to decrease the fuel consumption of gas turbine engines, for example, in terms of thrust Specific Fuel Consumption (SFC), in order to save operating costs, and to reduce their environmental impact due to carbon emissions and nitrous oxide (NOx). Such a need is felt in land, sea and air applications for gas turbine engines, but is particularly pressing for aircraft gas turbine engines due to the high cost of aviation fuel.

Gas turbine engines comprising “sequential” combustors have been proposed for use in electricity production. Examples include the GT24 gas turbine engine produced by Alstom™. In such gas turbine engines, a second combustor is provided downstream of a first combustor between upstream and downstream turbines. Such an arrangement is described for example in U.S. Pat. No. 5,941,060. Such a system comprises a pair of “constant pressure” combustors, in which fuel is burnt at approximately constant pressure between turbine stages. This fuel is then expanded in a separate downstream turbine stage.

Sequential combustors have also been proposed for aircraft gas turbine engines, particularly for military aircraft, for example in “Two-combustor Engines' Performance under Design and Off-design Conditions” by A S Lee, R Singh and S D Probert, presented at the 45^{th} AIAA/ASME/SAE/ASEE Joint Propulsion Conference and Exhibit in August 2009 (“Lee et al”). Such an arrangement may have greater efficiency at “off-design” conditions, i.e. where the engine is operated at thrust levels (and so overall pressure ratios) below the maximum. Gas turbine engines used in aircraft operate at off-design for most of their operational life, and so improvement in this area is particularly useful.

Lee et al discusses multi-spool gas turbine engines having a first combustor located upstream of a high pressure turbine, followed by a second combustor downstream of the high pressure turbine and upstream of a low pressure turbine. In each combustor, fuel is burnt at constant pressure, i.e. there is little pressure drop or rise from the upstream to the downstream end of the respective combustor. The low and high pressure turbines are coupled to independent shafts, and drive respective low and high pressure compressors, and so rotate independently of one another. Such an arrangement is known as a “two spool” or “two shaft” gas turbine engine, and provides high pressure ratios and therefore high efficiency. Such an arrangement is particularly beneficial for aircraft gas turbine engines.

However, the inventors have found that such an arrangement results in a variation of pressure ratios across the high pressure and low pressure turbines in dependence on the operation of the first and second combustors. Consequently, where the first and second combustors are operated non-synchronously (e.g. where the first combustor provides a constant turbine inlet temperature, and the second combustor provides a variable turbine inlet temperature, depending on required engine power), the turbine located between the first and second combustor will produce increased torque where the second combustor is operated at low power compared to when the second combustor is operated at high power in view of the higher pressure ratio across the turbine when the second combustor is operated at low power. Consequently, where the first turbine drives a first compressor, that first compressor will be operated at a higher rotational speed where the second combustor is operated at low power, thereby reducing compressor efficiency, and this may even cause stall or surge.

One proposed method for solving this problem is by providing variable nozzle guide vanes (NGVs) in the turbine downstream of the second combustor, and/or variable area nozzles downstream of the second turbine, to thereby control the pressure ratio across the second turbine. However, such arrangements require actuators operating in high temperature environments, and may therefore be relatively expensive, and insufficiently reliable for long term operation.

Consequently, there is a requirement for a gas turbine engine and a method of operation of a gas turbine engine which overcomes the above problem.

According to a first aspect of the invention there is provided a gas turbine engine comprising:

a first compressor coupled to a first turbine by a first shaft;

a second compressor coupled to a second turbine by a second shaft rotatable independently of the first shaft;

a first combustor located downstream of the first compressor and upstream of the first turbine; and

a second combustor located downstream of the first turbine, and upstream of the second turbine;

wherein the gas turbine engine comprises a coupling arrangement configured to selectively transfer power between the first shaft and the second shaft.

The arrangement of the present invention overcomes the above problem by selectively transferring power between the first and second shafts, thereby preventing overspeed of the first shaft where power is transferred from the second shaft to the first shaft, and/or reducing the maximum flow requirements of the first turbine where power is transferred from the first shaft to the second shaft. The above arrangement does not require actuators located in hot areas of the engine, and so can be provided at relatively low cost, and with high reliability.

The coupling arrangement may comprise a fluid coupling such as a torque converter comprising an input shaft coupled to the one of the first shaft and the second shaft and an output shaft coupled to the other shaft. Alternatively or in addition, the shaft coupling arrangement may comprise a mechanical clutch and/or a continuously variable transmission or a gearbox having a plurality of discrete ratios. The coupling arrangement may comprise an electric generator coupled to one of the first and second shafts, and an electric motor coupled to the other shaft, the electric generator being electrically coupled to the electric motor to thereby drive the electric motor.

The fluid coupling may comprise a first rotor coupled to the input shaft and a second rotor coupled to the output shaft, the first and second rotors being immersed in a transmission fluid within a fluid coupling housing. The transmission fluid may comprise aviation fuel. The gas turbine engine may comprise a fuel system configured to provide fuel from a fuel tank to an engine injector via the fluid coupling housing. Advantageously, any heat generated due to transmission inefficiencies of the fluid coupling is transferred to the combustor and thereafter to the turbines, thereby increasing the thermodynamic efficiency of the arrangement.

The fluid coupling may comprise a stator immersed within the transmission fluid. One or more of the first and second rotor and the stator may comprise a bladed disc. One or more of the first and second rotor and the stator may comprise a variable pitch mechanism configured to vary the pitch of blades of the first or second rotor or stator. Consequently, power transmitted from the high pressure shaft to the low pressure shaft can be selectively varied.

The gas turbine engine may comprise a three shaft gas turbine engine comprising a high pressure turbine coupled to a high pressure compressor by a high pressure shaft, an intermediate pressure turbine coupled to an intermediate pressure compressor by an intermediate pressure shaft and a low pressure turbine coupled to a low pressure compressor by a low pressure shaft, the high, intermediate and low pressure shafts being independently rotatable. The first turbine, first compressor and first shaft may comprise the high pressure turbine, compressor and shaft respectively, and the second turbine, compressor and shaft may comprise the intermediate pressure turbine, compressor and shaft respectively. Alternatively, the gas turbine engine may comprise a two shaft gas turbine engine comprises a high pressure turbine coupled to a high pressure compressor by a high pressure shaft and a low pressure turbine coupled to a low pressure compressor by a low pressure shaft. The first turbine, first compressor and first shaft may comprise the high pressure turbine, compressor and shaft respectively, and the second turbine, compressor and shaft may comprise the low pressure turbine, compressor and shaft respectively.

The gas turbine engine may comprise a controller configured to control power transfer between the first and second shafts via the coupling arrangement. The controller may comprise a proportional, integral, derivative (PID) controller.

According to a second aspect of the invention there is provided a method of operating a gas turbine engine in accordance with the first aspect of the present invention, the method comprising:

determining a first compressor non-dimensional rotational speed set point;

determining a current first shaft rotational speed and first compressor inlet temperature;

transferring power between the first and second shafts such that the first compressor non-dimensional rotational speed matches the set point.

The method may further comprise adjusting a further engine parameter such that the exit temperature of the first combustor is maintained at a predetermined set point when the second combustor is in operation. The exit temperature of the first combustor may be determined by measuring the turbine exit temperature (T42).

Embodiments of the invention will now be described by way of example only, with reference to the Figures, in which:

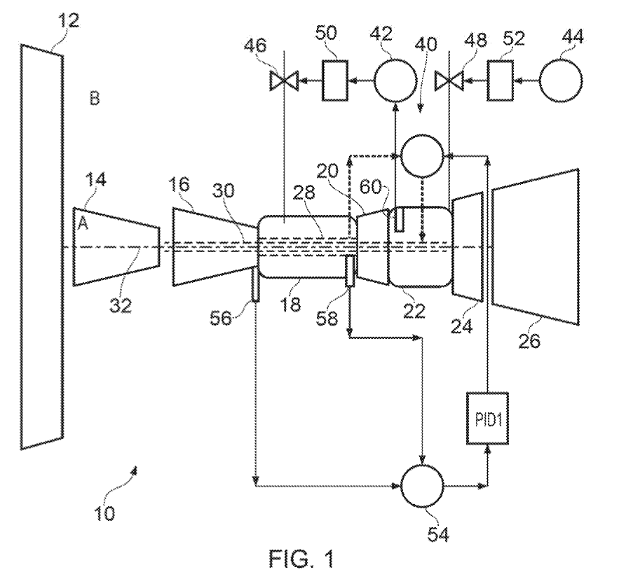

FIG. 1 is a schematic view of a gas turbine engine of the present invention;

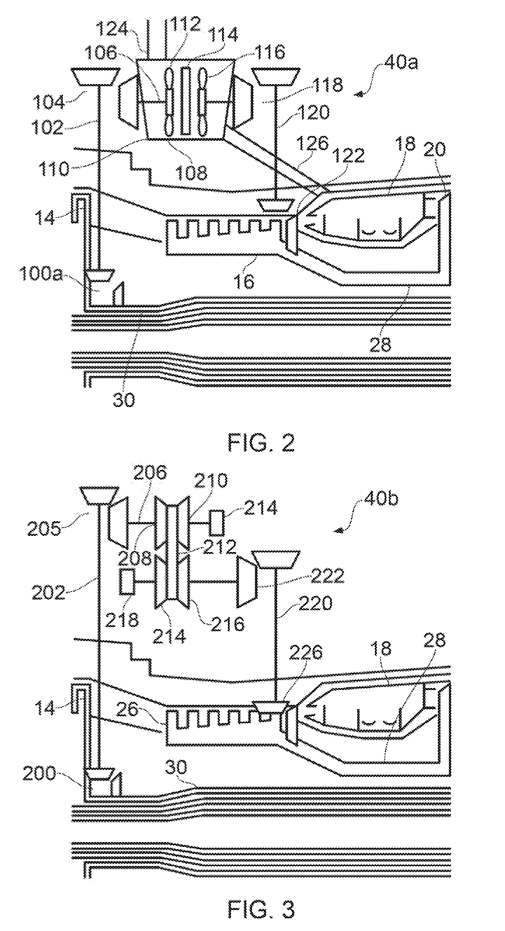

FIG. 2 is a schematic view of a first coupling arrangement of the gas turbine engine of FIG. 1;

FIG. 3 is a schematic view of a first alternative coupling arrangement of the gas turbine engine of FIG. 1

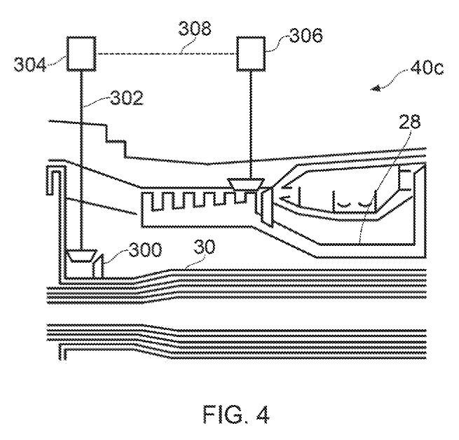

FIG. 4 is a schematic view of a second alternative coupling arrangement of the gas turbine engine of FIG. 1;

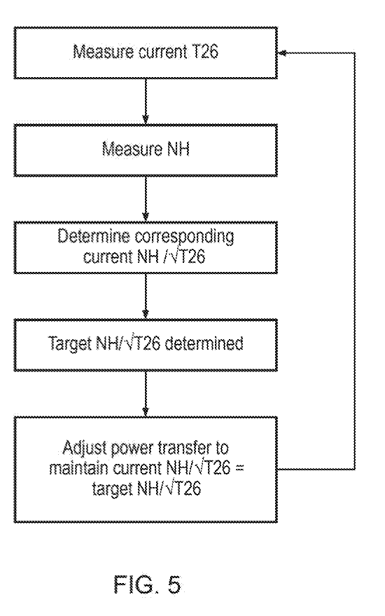

FIG. 5 is a flow diagram of a method of operating of the gas turbine engine of FIG. 1 during power transfer;

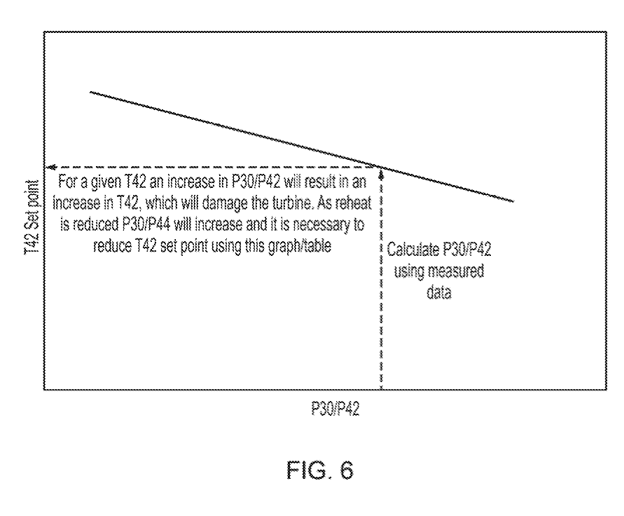

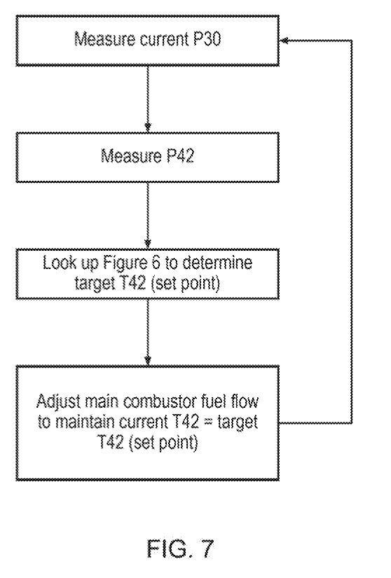

FIG. 6 is a graphical representation of a first look-up table to determine first combustor fuel flow to maintain T42;

FIG. 7 is a flow diagram of a method of controlling fuel flow to the first combustor of the gas turbine engine of FIG. 1; and

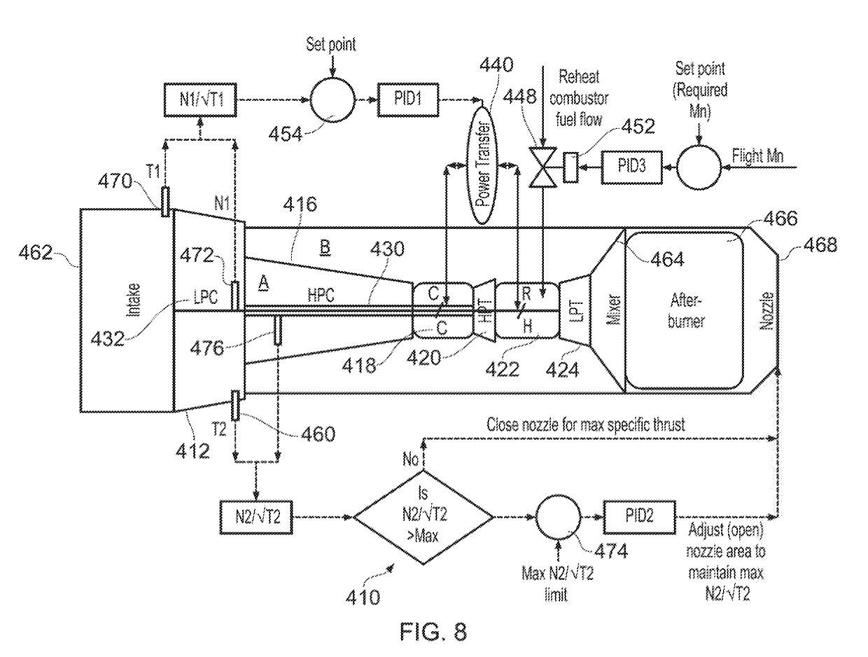

FIG. 8 is a schematic view of an alternative gas turbine engine of the present invention.

With reference to FIG. 1, a gas turbine engine is generally indicated at 10, having a principal and rotational axis. The engine 10 comprises, in axial flow series a propulsive fan 12, a first compressor in the form of an intermediate pressure compressor 14, a second compressor in the form of a high-pressure compressor 16, a first constant pressure combustor 18, a first turbine in the form of a high-pressure turbine 20, a second constant pressure combustor 22, a second turbine in the form of an intermediate pressure turbine 24, and a low-pressure turbine 26.

The gas turbine engine 10 works in the conventional manner so that air is accelerated by the fan 12 to produce two air flows: a first air flow A into the intermediate pressure compressor 14 and a second air flow B which passes through a bypass duct to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the first combustor 18 where it is mixed with fuel and the mixture combusted. The resultant hot combustion products then expand through, and thereby drive the high pressure turbine 20. Exhaust from the high pressure turbine 20 is directed into the second combustor 22 where further combustion takes before expanding through, and thereby driving, the intermediate and low-pressure turbines 24, 26 before being exhausted to provide additional propulsive thrust. The high 20, intermediate 224 and low 26 pressure turbines drive respectively the high pressure compressor 16, intermediate pressure compressor 14 and fan 12, each by suitable independently rotatable interconnecting relatively high, intermediate and low pressure shafts represented by dotted lines 28, 30, 32 respectively.

A coupling arrangement 40 is provided, which is configured to selectively transfer power between the high pressure shaft 28, and the intermediate pressure shaft 30. It will be understood that any suitable mechanical, electrical, magnetic, hydraulic or pneumatic transmission means may be employed, providing the transmission is capable of selectively transferring power.

FIG. 2 shows a first proposed coupling arrangement 40a. The coupling arrangement 40a comprises a radial drive shaft 102 driven by the intermediate pressure shaft 30 via a first bevel gear arrangement 100. The radial drive 102 is in turn coupled to an input shaft 106 of a torque converter 108 via a second bevel arrangement 104.

The torque converter 108 comprise a fluid filled housing 110a housing an input impeller 112 comprising a bladed rotor configured to impart swirl into the transmission fluid, a bladed stator 114 configured to control swirl of the transmission fluid, and an output turbine 116a, configured to convert swirl of the transmission fluid to torque. The output turbine 116 is coupled to the high pressure shaft 16 a third bevel arrangement 118, output radial drive 120 and fourth bevel arrangement 122.

In this embodiment, the transmission fluid comprises gas turbine engine fuel such as aviation fuel, and is transmitted to the housing 110 via a fuel supply conduit 124. A further fluid supply conduit 126 is provided, which extends between the housing 110 and the first combustor 18. Consequently, a continuous flow of aviation fuel is provided through the housing 110a, which both provides a medium within which the rotors 112, 11a and stator 114 may operate, and cooling to dissipate heat generated by the swirling of the fluid.

Since this fluid is then transferred to the combustor 18, the heat produced by the torque converter 108 is conserved within the thermodynamic cycle of the engine 10, and thus any inefficiency in the torque converter arrangement 108 is at least partially recovered by the turbines 20, 22, 24. Consequently, the above arrangement provides a highly efficient system. The torque converter 108 could also include a “lock-up” arrangement for mechanically locking the first and second shaft via a clutch, to thereby directly link the first and second shafts. One of the radial drives 102, 120 could be coupled to the respective shaft 30, 28 via gearing, which may increase or reduce the speed of the respective radial drive 102, 120 relative to the respective shaft 30, 28.

FIG. 3 shows a first alternative coupling arrangement 40b. The arrangement 40b comprises a radial drive shaft 202 driven by the intermediate pressure shaft 30 via a first bevel gear arrangement 200. The radial drive 202 is in turn coupled to an input shaft 206 of a continuously variable transmission arrangement (CVT) via a second bevel gear arrangement 205.

The CVT comprises first and second conical input rotors 208, 210 which are driven by the input shaft 206 and coupled to one another by a drive chain 212. A first actuator 214 varies the axial distance between the first and second rotors 208, 210 to thereby vary the effective outer diameter of the rotors 208, 210 where they engage with the chain 212, and so the input gearing of the CVT 204. The also chain 212 extends around third and fourth conical output rotors 214, 216, which are thereby rotated by the chain 212. The fourth rotor 216 is coupled to the high pressure shaft 28 via an output shaft 220, a third bevel arrangement 222, a second radial drive shaft 224 and a fourth bevel arrangement 226. The rotors 214, 216 are coupled to a second actuator 218 which again varies the axial distance between the conical rotors 214, 216 to thereby vary the output gearing of the CVT 204. In use, the actuators 214, 218 are operated synchronously, such that the gearing of the CVT 204 can be continuously varied without introducing slack or excessive tension into the chain 212. Torque from the intermediate pressure shaft 30 is thus transferrable to the high pressure shaft 28 via the coupling arrangement 40b.

FIG. 4 shows a second alternative coupling arrangement 40c. The arrangement 40c comprises a radial drive shaft 302 driven by the intermediate pressure shaft 30 via a first bevel gear arrangement 300. An electrical generator 304 is driven by the drive shaft 302, and provides electrical power to a variable speed electric motor 306 via an electrical interconnector 308. Consequently, power from the intermediate pressure shaft 30 can be transferred to the high pressure shaft 28 via the coupling arrangement 40c.

The gas turbine engine 10 further comprises a control arrangement comprising first and second fuel controllers 42, 44 which are each configured to control respective first and second fuel flow valves 46, 48 via respective actuators 50, 52. The control arrangement further comprises a coupling arrangement controller 54.

The controllers 42, 44 control the fuel flow via valves 46, 48 and actuators 20, 52 in accordance with the following method. At low engine thrust levels, such as around ground idle or slightly above, thrust is varied by operating only the first combustor 18, with the second combustor 22 being non-operational (i.e. with no fuel supplied to the second combustor 22). The amount of fuel supplied to the first combustor is varied 20 in accordance with required thrust level (with higher fuel flows corresponding to higher thrust levels) as determined by a schedule relating thrust level to a predetermined first combustor outlet temperature T42_{set point}. As the thrust level increases, the temperature immediately downstream of the first combustor 18 (i.e. the first combustor outlet temperature) increases. Temperatures downstream of the first combustor 20, such as the outlet of the high pressure turbine 20 (known in the art as T42) also increase. A maximum thrust in which only the first combustor 18 is operated is attained when T42 reaches a predetermined maximum T42ₘₐₓ as determined by a T42 sensor 60. T42 is generally correlated with combustor 18 exit temperature, and so a T42 measurement can be used to determine combustor exit temperature (which might be too high to measure directly). Once this temperature is reached, the second combustor 22 is brought into operation.

At higher engine thrust levels, where T42ₘₐₓ is reached, the thrust is varied by operating the second combustor 22 via the fuel valve 48, and varying the fuel flow through the second combustor 22 to provide the required thrust in accordance with an intermediate pressure turbine entry temperature set point. However, in this operation, T42ₘₐₓ, and so first combustor fuel flow, must be varied in proportion to the ratio of second compressor delivery pressure to high pressure turbine outlet pressure, i.e. P30/P42 in view of the effect that operation of the second combustor 22 has on high pressure turbine pressure ratio. Generally, T42ₘₐₓ can be increased as P30/P42 decreases, as shown in FIG. 6.

In a second step, the target high pressure compressor rotational non-dimensional speed NH/√T26, i.e. the ratio of rotational speed of the high pressure shaft 28 to the square root of T26 is maintained. This is done by adjusting the amount of power transferred between the high and intermediate shaft.

In general, the power transferred from the high pressure shaft 16 to the intermediate pressure shaft 14 by the coupling arrangement 40 is reduced as the fuelling is increased to the second combustor 22, and vice versa.

Consequently, the engine 10 can be controlled to prevent compressor overspeed without providing additional sensors. The intermediate and high pressure compressors 14, 16 may simultaneously be controlled in accordance with a compressor schedule through the use of bleed valves and variable inlet guide vanes. Alternatively, the above control method may replace such control methods and equipment, and therefore allow simplification of the engine due to deletion of some or all of the bleed valves and variable inlet guide vanes.

In the embodiment described herein, the coupling arrangement is configured to transfer variable power from the high pressure shaft to the low pressure shaft. The power transferred can vary between 0 and 1 MW depending on a requirement as determined by a controller 54.

In an alternative embodiment, the coupling arrangement may be configured to transfer variable power from the low pressure shaft to the high pressure shaft. The coupling arrangement is controlled as described in the above operating method, except that the relationship between power transfer and shaft rotational speeds is reversed, such that shaft power transfer will tend to increase high pressure shaft rotational speed. Consequently, shaft power transfer will be conducted where the second combustor is inoperative or at low power operation, and shaft power transfer will not be conducted (or will be conducted to a lesser extent) where the second combustor is operated or is at high power operation.

In a still further alternative, the coupling arrangement may be configured to transfer variable power in either direction between the high pressure and low pressure shafts. Again, such an arrangement can be controlled by the method described above.

FIG. 8 shows an alternative gas turbine engine 410 in accordance with the present invention. The engine 410 is configured for high speed operation at supersonic speeds of greater than Mach 1, and possibly greater than Mach 2.

The engine 410 comprises an inlet 462 configured to ingest air prior to entry into a low pressure compressor 412. The inlet may comprise a variable inlet ramp or shock cone as is conventional in the art of supersonic engine inlet, to control shocks at the inlet during supersonic operation.

The low pressure compressor 412 comprises a multi-stage axial flow compressor, comprises a plurality of rotors and stators (not shown). The compressor 412 is configured to compress air, and provide a bypass flow B, and a core flow A downstream. The low pressure compressor 412 therefore has a similar operation to the fan of the first embodiment, but in this case, the pressure ratio across the low pressure compressor 412 is generally higher than that of the fan 12, and the bypass ratio is generally lower, of the order of 1. Consequently, the engine 410 provides a higher specific thrust (i.e. the ratio between net thrust and total inlet flow).

Downstream in core flow A is a high pressure compressor 416. The high pressure compressor is similar to the low pressure compressor 412, and is again configured to compress air passing therethrough, and pass this to further equipment downstream in the core flow A.

Still further downstream in core flow A is a first combustor 418. The first combustor is configured to add and burn fuel with air in the core flow A, and thereby raise the temperature of the core flow A.

Downstream of the first combustor 418 is a high pressure turbine 420. The high pressure turbine 420 is configured to extract work from the core flow A, and thereby rotate the high pressure compressor 416 with which the high pressure turbine 420 is coupled via a high pressure shaft 430.

Downstream of the high pressure turbine 420 is a second combustor 422, which is similar to the first combustor 420, and is configured to again raise the temperature of the core flow A by combusting further fuel therewith.

A low pressure turbine 424 is provided downstream of the second combustor 422, and is configured to extract further work from the core flow A, and thereby rotate the low pressure compressor 412 with which the low pressure turbine 424 is coupled via a low pressure shaft 432.

Optionally a mixer 464 is provided downstream of the low pressure turbine 424 in the core flow A, and also downstream of the fan 412 in the bypass flow A. Consequently, the mixer 464 combines flows A and B to formed a mixed flow downstream of the mixer. If a mixer is not present then the LPC/Fan exit flow (B) in 410 will exhaust through its own (cold) nozzle. This would be similar to FIG. 1 in architecture.

The engine 410 further optionally comprises a third combustor in the form of an afterburner 466 downstream of the mixer 464. The afterburner 466 is configured to add further fuel to the mixed exhaust flow, and thereby further raise the temperature of the mixed flow.

Downstream of the afterburner is a variable area nozzle 468. The nozzle 468 comprises actuators (not shown) to vary the outlet area of the nozzle. consequently, the nozzle 468 serves to control the mass flow through the engine 410, and control the bypass ratio. In general, where the nozzle 468 area is small, the bypass ratio is reduced (i.e. less bypass flow B is provided relative to core flow A), and vice versa.

The engine 410 further comprises a coupling arrangement 440, which is configured to selectively transfer power between the high pressure and low pressure shafts 430, 432. The coupling 440 could comprise any of the arrangements shown in FIGS. 2 to 4.

During operation, fuel flow to each of the combustors 418, 422, 466 is controlled independently of one another. In general, it is desirable to maximise the temperature T40 of air exiting the first combustor 418 within the tolerances of high pressure turbine 420 in order to maximise efficiency. Consequently, combustor 418 fuel flow is generally constant during normal operation, with combustor 418 fuel flow only being reduced at relatively low engine power settings. During these conditions, fuel flow to the second and third combustors 422, 466 will generally be stopped.

In contrast, fuel flow to the second and third combustors 422, 466 is varied during different stages of the flight cycle. For example, above a first threshold thrust level, the first combustor fuel flow 418 may be adjusted such that T40 is held constant at a maximum temperature T40_{MAX}, with the second combustor 422 fuel flow varied by a controller 452 in dependence of required thrust, as determined by a comparison between an aircraft speed set point (such as Indicated Airspeed or flight Mach number) and a measured aircraft speed. In general, the thrust level is increased or reduced by the controller 452 by actuating a fuel valve 448 such that the measured aircraft speed matches the set point.

If a second combustor 422 maximum fuel flow rate or low pressure turbine entry temperature T50 is reached, while the measured aircraft speed is less than the aircraft speed set point, then the afterburner 466 may be operated. Again, afterburner fuel flow is modulated in accordance with a comparison between measured aircraft speed and the aircraft speed set point, with each of the first and second combustors 418, 422 being operated at their maximum respective fuel flows or turbine entry temperatures.

Simultaneously, the engine 410 must be controlled such that the low pressure and high pressure compressors 412, 416 operate within their respective operating margins. The engine 410 comprises a coupling arrangement controller 454, which controls shaft power transfer between the high pressure and low pressure shafts 430, 432 by the coupling arrangement 440.

The engine 410 comprises a T1 sensor 470 configured to determine a temperature of inlet air prior to entry to the low pressure compressor 412. The engine 410 further comprises a low pressure shaft speed (N1) sensor 472 configured to determine a low pressure shaft 432 rotational speed. The sensors 470, 472 may directly measure these parameters, or infer them from indirect measurements. Temperature and shaft speed measurements from the sensors 470, 472 can then be used to calculate a measured low pressure compressor corrected speed N1/\sqrt{T1}, by dividing the compressor shaft rotational speed measurement N1 by a square root of the absolute compressor inlet temperature T1. Optionally, N1 can also be used instead of N1/\sqrt{T1}.

The measured low pressure shaft corrected speed is then compared to a set point, which is determined in accordance with a look-up table. The look-up table may relate the low pressure shaft corrected speed set point to a current ambient temperature and Mach number. Again, the ambient temperature may be directly measured by respective sensors (not shown), or inferred from other parameters. The tabulated values of the look-up table may be determined by engine test data.

The coupling arrangement 440 is then controlled by the controller 545 such that the measured low pressure shaft speed (N1) or corrected speed (N1/√T1) substantially matches the set point. In general, as in the previous embodiment, power is transferred from the high pressure shaft 416 to the low pressure shaft 412 by the coupling arrangement 440 in order to reduce the low pressure shaft corrected speed, and vice versa depending on the shaft speed relative to the required set point.

Simultaneously, a propelling nozzle controller 474 is employed to control the outlet area of the variable area nozzle 468. The engine 410 comprises a high pressure compressor inlet temperature T2 sensor 460, configured to measure high pressure compressor inlet temperature T2. Similarly, the engine 410 comprises a high pressure shaft rotational speed N2 sensor 476. Again, these sensors could obtain direct measurements of these parameters, or obtain them indirectly. Temperature and shaft speed measurements from the sensors 460, 476 can then be used to calculate a measured high pressure compressor corrected speed N2/\sqrt{T2}, by dividing the high pressure compressor shaft rotational speed measurement N2 by a square root of the absolute high pressure compressor inlet temperature T2. Again, optionally N2 can be used instead of N2/\sqrt{T2}.

The controller 474 then compares the measured high pressure shaft corrected rotational speed to a predetermined maximum high pressure shaft corrected rotational speed. If the measured high pressure shaft corrected rotational speed is less than the predetermined maximum high pressure shaft corrected rotational speed, the controller 474 commands the nozzle 468 to close to a position which provides a predetermined minimum outlet area. The predetermined minimum outlet area is determined in accordance with a low pressure compressor 412 surge margin, again determined in accordance with a lookup table. By reducing the nozzle 468 outlet area to a minimum, the bypass ratio will be reduced, thereby increasing the specific thrust of the engine, and so increasing efficiency at high Mach numbers.

On the other hand, reducing the bypass ratio by closing the nozzle 468 will necessarily increase the mass flow into the core, thereby increasing the high pressure compressor 416 rotational speed. Consequently, the controller 474 is configured to compare the corrected high pressure shaft rotational speed to a set point, and adjusts the nozzle 468 such that the high pressure compressor corrected rotational speed is contained within limits.

It will be understood that the invention is not limited to the embodiments above-described and various modifications and improvements can be made without departing from the concepts described herein.

For example, different types of fluid couplings could be employed. Different types of continuously variable transmissions could be employed, for example those operating on a magnetic principle. The invention is equally applicable to gas turbine engines having only two shaft, or more than three shafts. The invention is also applicable to engines comprising geared fans and/or propellers. The invention is also applicable to non-aircraft gas turbine engines, such as marine gas turbine engines used to power ships or land-based gas turbine engines used to generate electricity. The gas turbine engine could be controlled in accordance with a different control scheme.

The engine may further comprise an arrangement for extracting power from one or more shafts independently of the coupling arrangement. For example, the arrangement may comprise an electrical generator coupled to one or more shafts. The generator may comprise a controller configured to control the power output of the generator (and so the torque applied to the shaft to which the generator is coupled) in dependence on engine operating considerations such as compressor operability margin. This controller could control the shafts to assist the coupling arrangement in increasing/reducing the rotational speed of one of the shafts where the second combustor is turned on or off, or throttled.

Except where mutually exclusive, any of the features may be employed separately or in combination with any other features and the disclosure extends to and includes all combinations and sub-combinations of one or more features described herein.

1. A gas turbine engine comprising:
a first compressor coupled to a first turbine by a first shaft;
a second compressor coupled to a second turbine by a second shaft rotatable independently of the first shaft;
a first combustor located downstream of the first compressor and upstream of the first turbine; and
a second combustor located downstream of the first turbine, and upstream of the second turbine;
wherein the gas turbine engine comprises a coupling arrangement configured to selectively transfer power between the first shaft and the second shaft.

2. An engine according to claim 1, wherein the coupling arrangement comprises a fluid coupling such as a torque converter comprising an input shaft coupled to one of the first shaft and the second shaft and an output shaft coupled to the other shaft.

3. An engine according to claim 1, wherein the shaft coupling arrangement comprises a mechanical clutch and/or a continuously variable transmission or a gearbox having a plurality of discrete ratios.

4. An engine according to claim 1, wherein the coupling arrangement comprises an electric generator coupled to the high pressure shaft, and an electric motor coupled to the low pressure shaft, the electric generator being electrically coupled to the electric motor to thereby drive the electric motor.

5. An engine according to claim 2, wherein the fluid coupling comprises a first rotor coupled to the input shaft and a second rotor coupled to the output shaft, the first and second rotors being immersed in a transmission fluid within a fluid coupling housing.

6. An engine according to claim 5, wherein the transmission fluid comprises aviation fuel.

7. An engine according to claim 6, wherein the engine comprises a fuel system configured to provide fuel from a fuel tank to an engine injector via the fluid coupling housing.

8. An engine according to claim 5, wherein the fluid coupling comprises a stator immersed within the transmission fluid.

9. An engine according to claim 8, wherein one or more of the first and second rotor and the stator comprises a bladed disc and one or more of the first and second rotor and the stator comprises a variable pitch mechanism configured to vary the pitch of blades of the first or second rotor or stator.

10. An engine according to claim 1, wherein the gas turbine engine comprises a three shaft gas turbine engine comprising a high pressure turbine coupled to a high pressure compressor by a high pressure shaft, an intermediate pressure turbine coupled to an intermediate pressure compressor by an intermediate pressure shaft and a low pressure turbine coupled to a low pressure compressor by a low pressure shaft, the high, intermediate and low pressure shafts being independently rotatable, wherein he first turbine, first compressor and first shaft comprise the high pressure turbine, compressor and shaft respectively, and the second turbine, second compressor and second shaft comprise the intermediate pressure turbine, compressor and shaft respectively.

11. An engine according to claim 1, wherein the engine comprises a controller configured to control power transfer from the relatively high pressure shaft to the relatively low pressure shaft via the coupling arrangement.

12. A method of operating a gas turbine engine in accordance with claim 1, the method comprising:
determining a first compressor non-dimensional rotational speed set point;
determining a current first compressor rotational speed and first compressor inlet temperature;
transferring power between the first and second shafts such that the first shaft rotational speed matches the set point.

13. A method according to claim 12, wherein the method further comprises adjusting a further engine parameter such that exit temperature of the first combustor is maintained at a predetermined set point when the second combustor is in operation.
